(19) United States
(12) Patent Application Publication
(10) Pub. No.: US 2011/0274585 A1
(43) Pub. Date: Nov. 10, 2011

(54) MIXING CARTRIDGE AND SAMPLE TESTING DEVICE

(75) Inventors: Hirohisa Miyamoto, Tokyo (JP); Takeshi Kinpara, Tokyo (JP); Yoshiaki Nakamura, Tokyo (JP)

(73) Assignee: KABUSHIKI KAISHA TOSHIBA, Tokyo (JP)

(21) Appl. No.: 13/150,658

(22) Filed: Jun. 1, 2011

Related U.S. Application Data
(63) Continuation of application No. PCT/JP2009/068194, filed on Oct. 22, 2009.

(30) Foreign Application Priority Data
Dec. 1, 2008 (JP) 2008-306564

(51) Int. Cl. G01N 21/00; B01L 3/00

(52) U.S. Cl. 422/82.05; 422/554

(57) ABSTRACT

According to one embodiment, a mixing cartridge mixes a first solution containing a sample with a second solution corresponding to a measurement item of the sample to be tested. The mixing cartridge includes a member, a first liquid supplying unit, a second liquid supplying unit, and a separating unit. A channel is formed in the member. A solution containing at least one of the first solution and the second solution passes through the channel. The first liquid supplying unit supplies the first solution to the channel. The second liquid supplying unit supplies the second solution to the channel. The separating unit communicates with the channel and separates a portion of the solution from the solution passing through the channel by capillary action.

### CROSS-REFERENCE TO RELATED APPLICATIONS

This application is a continuation of PCT international application Ser. No. PCT/JP2009/068194 filed on Oct. 22, 2009 which designates the United States and claims the benefit of priority from Japanese Patent Application No.2008-306564 filed on Dec. 1, 2008; the entire contents of which are incorporated herein by reference.

### FIELD

Embodiments described herein relate generally to a mixing cartridge that mixes a sample with a reaction reagent, and a sample testing device that optically tests the sample using a mixed solution mixed by the mixing cartridge.

### BACKGROUND

There are sample testing devices that measure various biological materials such as ions, gas components, biochemical components, and the like contained in a sample, which is a biological liquid such as blood or urine. Among conventional sample testing devices, the mainstream has been relatively large devices that are generally installed in blood centers of main hospitals or the like and can measure up to a maximum of several hundreds of kinds of items.

In recent years, there has been an increasing demand for development of a small sample testing device and there is also a call for development of a mechanism for detecting biological materials with high sensitivity even from a trace of sample.

As one of those technologies, there is a technology of supplying a mixed solution of a sample and a reagent to a microchannel and performs an optical measurement with the sample (For example, see JP-A 2006-217818 (KOKAI)).

JP-A 2006-217818 (KOKAI) discloses a case in which two reagents are mixed with each other with use of a Y-shaped channel. If individual reagent liquids are simultaneously sent, a mixing ratio in a head part of a mixed solution is not stable. Thus, it is desirable to discard the head part of the mixed solution and send the remaining part of the mixed solution, in which the mixing ration is stable, to the next process.

However, in JP-A 2006-217818 (KOKAI) cited above, there is no description about a specific technique regarding how to discard the head part of the mixed solution (the part where a mixing ratio is unstable). Furthermore, a test cannot be performed with a trace of sample with high accuracy.

### BRIEF DESCRIPTION OF THE DRAWINGS

FIG. 1 is a block diagram schematically illustrating the structure of a sample testing device according to a first embodiment;

FIG. 2 is a schematic diagram illustrating the structure of a mixing cartridge according to the first embodiment;

FIG. 3A is a diagram showing an example of operation performance of a syringe pump;

FIG. 3B is a diagram showing an example of operation performance of a syringe pump;

FIG. 4A is an explanatory diagram illustrating a state of a sample and a first reagent immediately before they are mixed together;

FIG. 4B is a diagram illustrating a state when an uncertain mixed solution α starts to pass through the inside of a microchannel;

FIG. 4C is an explanatory diagram illustrating a state when a mixed solution β with a stable mixing ratio passes through the inside of the microchannel, following the uncertain mixed solution α;

FIG. 5A is an explanatory diagram illustrating a state when the uncertain mixed solution α has passed through the inside of the microchannel and reached a branching point;

FIG. 55 is an explanatory diagram illustrating a state when the uncertain mixed solution α is sucked up through a first discard microchannel;

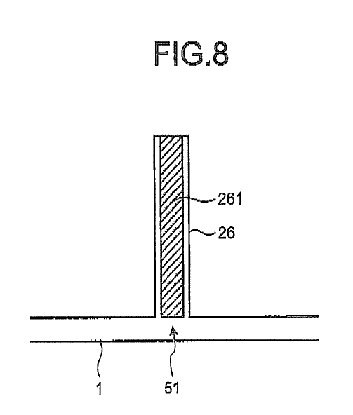

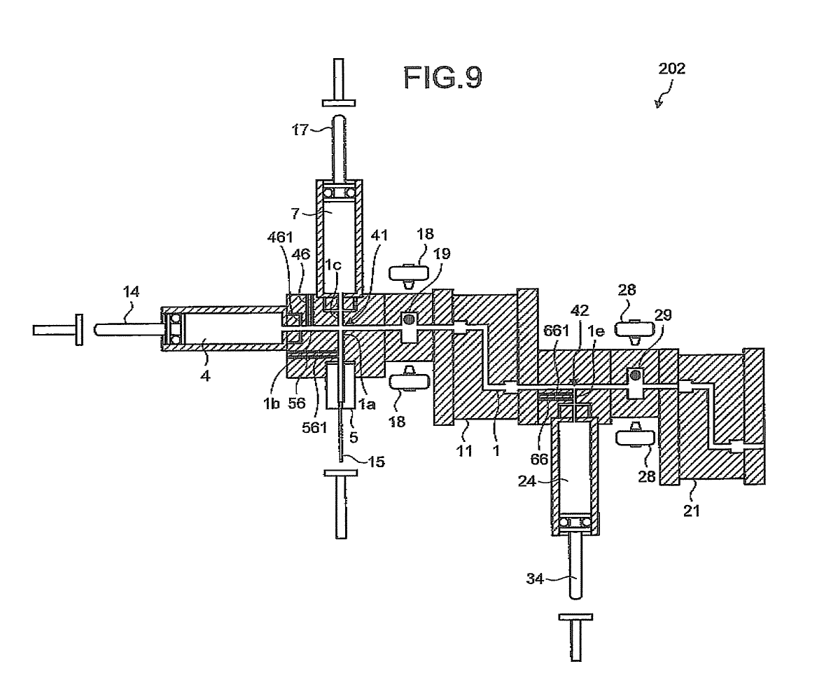

FIG. 5C is an explanatory diagram illustrating a state when the mixed solution β with a stable mixed ratio passes through the inside of the microchannel;

FIG. 6 is a block diagram illustrating the functional structure of a control unit;

FIG. 7 is a schematic diagram illustrating the structure of a mixing cartridge according to a second embodiment;

FIG. 8 is an explanatory diagram illustrating the details of a first discard microchannel; and

FIG. 9 is a schematic diagram illustrating the structure of a mixing cartridge according to a third embodiment.

### DETAILED DESCRIPTION

In general, according to one embodiment, a mixing cartridge mixes a first solution containing a sample with a second solution corresponding to a measurement item of the sample to be tested. The mixing cartridge includes a member, a first liquid supplying unit, a second liquid supplying unit, and a separating unit. A channel is formed in the member. A solution containing at least one of the first solution and the second solution passes through the channel. The first liquid supplying unit supplies the first solution to the channel. The second liquid supplying unit supplies the second solution to the channel. The separating unit communicates with the channel and separates a portion of the solution from the solution passing through the channel by capillary action.

Hereinbelow, with reference to the accompanying drawings, embodiments of a mixing cartridge and a sample testing device will be described in detail.

### First Embodiment

In a mixing cartridge that mixes a trace of sample and reaction reagent and a sample testing device that tests the sample with the mixing cartridge, it is important to obtain a mixed solution, in which the sample and the reaction reagent are stabilized, in a microchannel through which the solution passes. The microchannel according to the embodiments means a channel capable of supplying, for example, hundreds of nanoliters (nL) to tens of microliters (μL) as a total flow volume; however, the microchannel is not limited thereto and other channels may be employed as long as achieving similar objects to those by the embodiments.

However, when a sample is mixed with various reaction reagents to obtain mixed solutions, a considerable variation occurs until the mixed solution becomes homogeneously mixed and stabilized in tine microchannel, depending on measurement items (i.e., depending on a reaction reagent used in a test, a mixing ratio of a reaction reagent, an operation delay of a pump that supplies a reagent or the like, etc.). That is, an amount of an unstable and uncertain solution part that has been obtained before a stable mixed solution is obtained is different, depending on measurement items or mixing ratios. Accordingly, the part of the mixed solution where the uncertain solution is present is different. Embodiments described below are capable of separating an appropriate amount of the uncertain solution part (part of the mixed solution), from the mixed solution, corresponding to the measurement item.

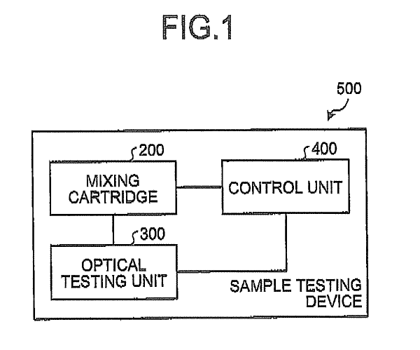

FIG. 1 is a block diagram schematically illustrating the structure of a sample testing device 500 according to a first embodiment. The sample testing device 500 includes a mixing cartridge 200 that mixes a sample with a reaction reagent, an optical testing unit 300 that optically tests a mixed solution mixed by the mixing cartridge 200, and a control unit 400 that controls operations of the mixing cartridge 200 and the optical testing unit 300. In the sample testing device 500 according to this embodiment, it is conceivable that the mixing cartridge 200 is a disposal type which is discarded each time a sample is tested. This is to prevent leakage of the sample or the like out of waste parts of medical waste and to maintain the safety and health.

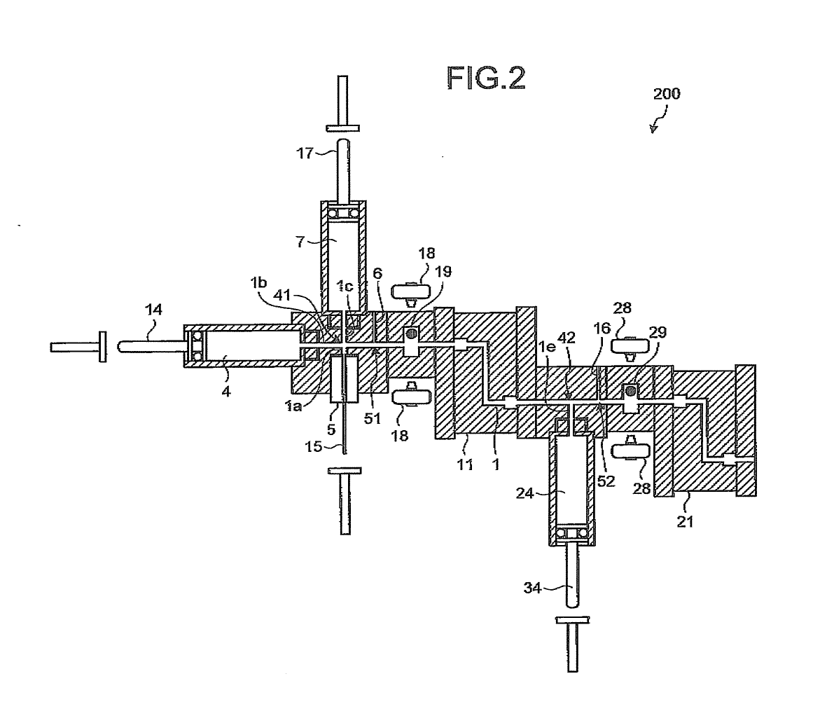

FIG. 2 is a schematic diagram illustrating the structure of the mixing cartridge 200 according to the first embodiment. As shown in FIG. 2, the mixing cartridge 200 includes a first photometry cell 11 and a second photometry cell 21 that perform optical tests and further includes a microchannel 1 formed therein. The microchannel 1 communicates with a first reagent tank 4, a sample tank 5, an oil tank 7, a second reagent tank 24, a first discard microchannel 6, and a second discard microchannel 16. The tanks communicate with the microchannel 1, respectively through a microchannel 1a, a microchannel 1b, a microchannel 1c, and a microchannel is that are parts of the microchannel 1. The microchannel 1, the first discard microchannel 6, and the second discard microchannel 16 are formed in the mixing cartridge 200.

In the mixing cartridge 200, a first reagent sent from the first reagent tank 4 and a sample sent from the sample tank 5 are mixed, and the mixed solution resulting from the mixing passes toward the first photometry cell 11. In the first photometry cell 11, with the mixed solution of the first reagent and the sample, the sample is tested. Subsequently, a second reagent is further mixed with the mixed solution of the first reagent and the sample, and the resulting mixed solution obtained through the mixing passes toward the second photometry cell 21. In the second photometry cell 21, with the mixed solution of the first reagent, the sample, and the second reagent, the sample test is performed. As for the microchannel 1 of the mixing cartridge 200 of this embodiment, a discharge port, which is disposed near the second photometry cell 21 and from which the mixed solution is discharged out, is broader than the vicinity of a solution sending port, through which a solution of a sample, a reaction reagent, and the like from each tank is sent in.

The first reagent tank 4, the sample tank 5, the oil tank 7, and the second reagent tank 24 are provided with a first reagent pump 14, a sample pump 15, an oil pump 17, and a second reagent pump 34, respectively. The first reagent pump 14, the sample pump 15, the oil pump 17, and the second reagent pump 34 are syringe type pumps and supply a solution stored in the corresponding tanks to the microchannel 1 in a manner of pushing a solution.

The microchannel 1b communicating with the first reagent tank 4, the microchannel 1a communicating with the sample tank 5, and the microchannel 1c communicating with the oil tank 7 are arranged to merge with one another at the same location, which is at a confluent point 41 of the microchannel 1. It is configured such that the first reagent, the sample, and the oil merge with one another at the confluent point 41 and thus are confluent through the microchannel 1. The first discard microchannel 6 branches off from the microchannel 1 in a way of communicating with the microchannel 1, at a position of the microchannel 1, which is on the downstream of the flow of the solution from the confluent point 41 of the first reagent, the sample, and the oil, and is also on the upstream of the flow of the solution from a location where a first magnet 19 which will be described later is installed. The position is specifically in the vicinity of a midway position between the confluent point 41 and the installation position of the first magnet 19. The first discard microchannel 6 is formed to have a diameter smaller than the diameter of the microchannel 1 to partially suck up, through the inside of the first discard microchannel 6, the mixed solution that is a mixture of the sample and the first reagent and is passing through the microchannel 1 by capillary action, thereby separating part of the mixed solution from the remaining part of the mixed solution.

On the upstream from the first photometry cell 11 in which the sample is tested, the first magnet 19 as an agitating member that agitates a solution is installed inside the microchannel 1 disposed on the downstream from a branching point 51 between the first discard microchannel 6 and the microchannel 1. In addition, a first agitation control unit 18 is installed around the first magnet 19 outside the microchannel 1. The first agitation control unit 18 is composed of a pair of electromagnets and causes the first magnet 19 inside the microchannel 1 to vibrate by alternately turning on/off a current flowing through the electromagnets, thereby agitating the mixed solution of the sample and the first reagent. In this embodiment, a magnet (the first magnet 19) is provided as the agitating member to agitate a solution. However, the agitating member is not limited thereto and other members may be employed as long as they are made of a material having a ferromagnetic property. This is also similarly applied to a second magnet 29 which will be described later.

On the downstream from the first magnet 19, the first photometry cell 11 is disposed which performs an optical test by emitting light. It is preferable that the first photometry cell 11 uses a material with high light transmittance so as not to cause a testing error. The mixed solution that has reached the first photometry cell 11 is tested with the optical testing unit 300 (see FIG. 1) incorporated in the sample testing device.

The second reagent tank 24 is disposed to merge and communicate with the microchannel 1 on the downstream from the first photometry cell 11. As in the case of the first reagent, the second discard microchannel 16 branches off from the microchannel 1 in a way of communicating with the microchannel 1 at the location which is on the downstream from a confluent point 42 of the second reagent tank 24 and the microchannel 2 and on the upstream from the installation position of a second magnet 29 which will be described later. That is, the location is a midway position between the confluent point 42 and the second magnet 29.

The second magnet 29 for agitating a solution is installed inside the microchannel 1 disposed on the downstream from a confluent point 52 of the second discard microchannel 16 and the microchannel 1. A second agitation control unit 28, which operates the second magnet 29 and has the same structure as the first agitation control unit 18, is installed around the second magnet 29 outside the microchannel 1.

The second photometry cell 21 that performs an optical test by emitting light is installed on the downstream from the second magnet 29. It is preferable that the second photometry cell 21 uses a material with high light transmittance so as not to cause a testing error like the case of the first photometry cell 11. The mixed solution that has reached the second photometry cell 21 is tested with the optical testing unit 300 (see FIG. 1) incorporated in the sample testing device.

The mixing cartridge 200 of this embodiment has a structure composed of almost all of the components illustrated in FIG. 2 excluding the agitation control units 18 and 28. Specifically, the mixing cartridge 200 of this embodiment includes a microchannel 1 (inclusive of microchannels 1a, 1b, 1c, and 1e), a first photometry cell 11, a second photometry cell 21, a first reagent tank 4, a sample tank 5, en oil tank 7, a second reagent tank 24, a first discard microchannel 6, and a second discard microchannel 16. It may further include a first magnet 19 and a second magnet 29 that are necessary for agitation as internal components of the mixing cartridge 200, if necessary.

Depending on the specification of the sample testing device 500, the components of the mixing cartridge 200, such as individual tanks (a first reagent tank 4, a sample tank 5, an oil tank 7, and a second reagent tank 24) filled with a sample, reagents, and an oil, are not necessarily integrated with the mixing cartridge 200. In practical use, these tanks and other components other than the tanks may be combined with the above structure to function as the mixing cartridge.

Next, operation of a sample testing device 500 including the mixing cartridge 200 of this embodiment will be described, The sample tank 5 contains a biological fluid such as blood, urine, or the like as a sample. The sample is pushed by the sample pump 15 to be sent to the microchannel 1. The first reagent tank 4 selectively contains a first reagent (reaction reagent) corresponding to a measurement item of the sample to be tested, and is sent to the microchannel 1 by the first reagent pump 14. Sometimes, it is necessary to use two reaction reagents, depending on measurement items. Accordingly, a second reagent which is an additional reagent other than the first reagent may be contained in the second reagent tank 24, and may be sent to the microchannel 1 by the second reagent pump 34. The first reagent and the sample are sent so as to be simultaneously supplied to the confluent point 41 inside the microchannel 1. When the first reagent and the sample merge with each other at the confluent point 41, a mixed solution thereof is obtained.

However, the driving operation of a pump such as the sample pump 15, the first reagent pump 14, and the like involves a time difference between timing when the pump receives a driving signal and timing when the pump enters a normal operation state of giving a predetermined flow rate. This time difference varies depending on the predetermined flow rate which is a target flow rate of the pump.

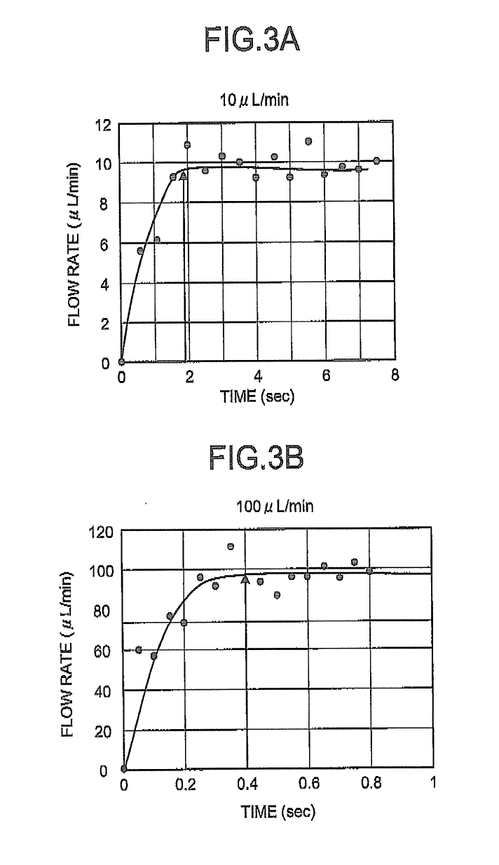

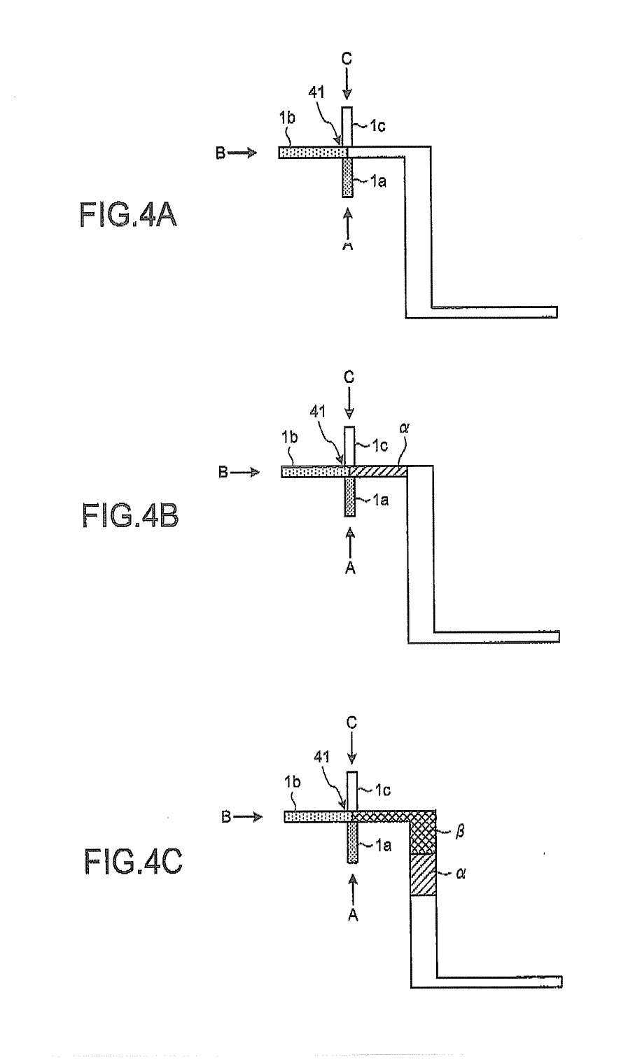

Here, operational performance of a pump will be described. FIG. 3A is a graph illustrating an example of operational performance of a pump when a rated flow rate of a syringe pump is 10 μL/min. FIG. 3B is a graph illustrating an example of operational performance of a pump when a rated flow rate of a syringe pump is 100 μL/min. The lateral axis indicates the elapsed time from when the pump receives an electrical driving signal and the vertical axis indicates the flow rate of a fluid by the pump.

In any type of solution sending pumps, there is a slight time difference between reception of an electrical driving signal and starting of operation, or between reception of an electrical driving signal and timing when a rated flow rate is obtained after starting of operation. The elapsed time until the pump enters a normal operation state of giving a rated flow rate varies depending on the rated flow rate. For example, the elapsed time is 2 seconds in FIG. 3A but 0.4 seconds in FIG. 3B. Until the pump enters a normal operation state, the constant flow rate of a solution cannot be ensured.

When a measurement item of a sample to be tested is determined, the rated flow rates of the sample pump 15 and the first reagent pump 14 are set so as to satisfy a predetermined mixing ratio. When a pump is set to give a certain rated flow rate, the time elapsed until the normal operation state and the sending amount of a solution for the time are unique values for each pump. Accordingly, in a system of mixing a sample with a reaction reagent with a predetermined ratio by continuously sending solutions through the microchannel 1 as in this embodiment, a part of the mixed solution that has obtained before both of the sample pump 15 and the first reagent pump 14 enter the normal operation state, and a part of the mixed solution that has obtained before the second reagent pump 34 enters the normal operation state are uncertain in mixing ratio. Therefore, they cannot be used for a test and thus need to be separated from the microchannel 1. The amount of a mixed solution, which is uncertain and has obtained until the mixing ratio depending on the driving characteristics of the sample pump 15, the first reagent pump 14, and the second reagent pump 34 becomes stable (hereinafter, referred to as “an uncertain mixed solution”), is determined depending on the measurement item.

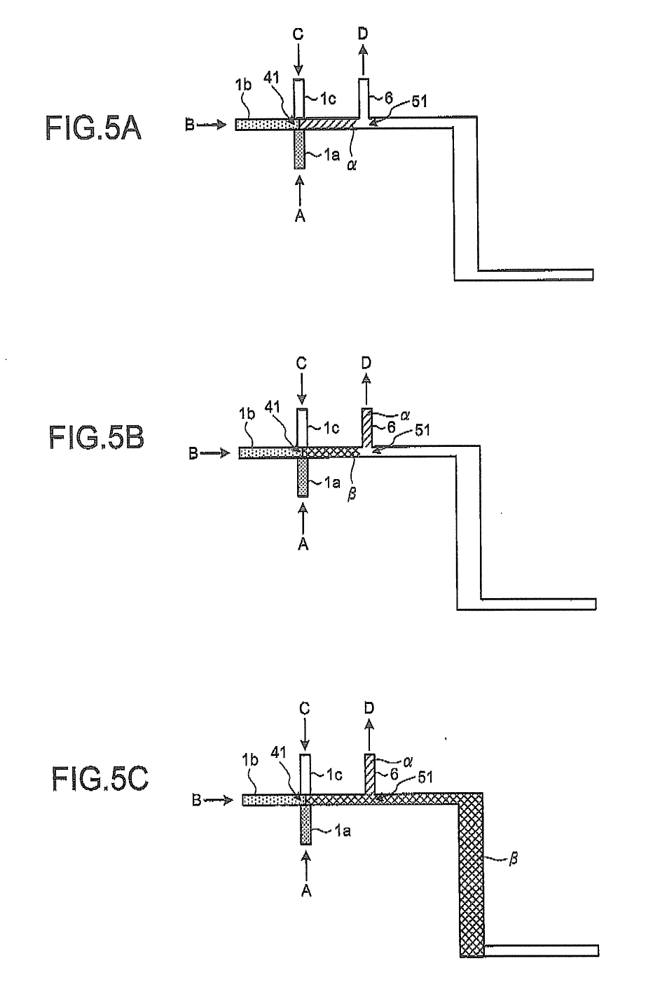

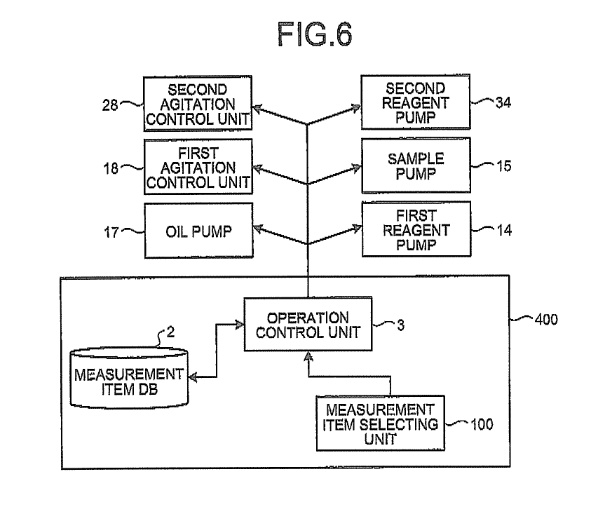

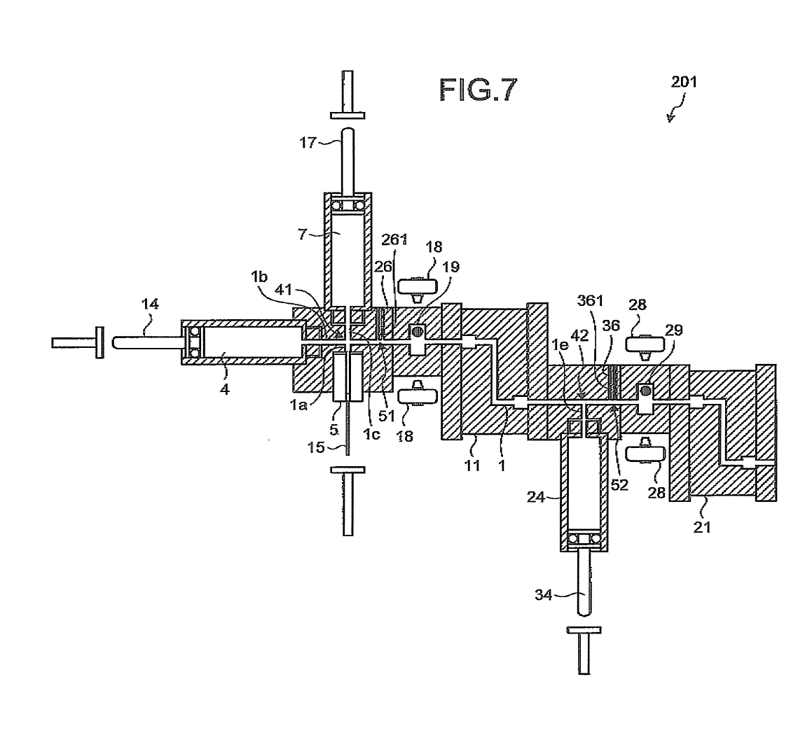

Hereinafter, a description will be made on a case where the uncertain solution, obtained in a manner such that the sample is merged and mixed with the first reagent, passes through the microchannel 1, with reference to the drawings. FIGS. 4A, 4B, and 4C are explanatory diagrams when the uncertain mixed solution passes through the inside of the microchannel 1. FIG. 4A is an explanatory diagram illustrating a state shortly before the sample and the first reagent are mixed. FIG. 4B is an explanatory diagram illustrating a state in which the uncertain mixed solution α starts to pass through the inside of the microchannel 1. FIG. 4C is an explanatory diagram illustrating a state in which the sample and the first reagent are mixed, and a mixed solution β that is stable in mixing ratio is passing through the inside of the microchannel 1, following the uncertain mixed solution α, As shown in FIG. 4A, the microchannel 1a is supplied with the sample sent in a direction A from the sample tank 5, and the microchannel 1b is supplied with the first reagent sent in a direction B from the first reagent tank 4. The sample and the first reagent merge with each other at the confluent point 41. After the sample and the first reagent are mixed, the microchannel 1c is supplied with the oil sent in a direction C from the oil tank 7.

In a case where the sample and the first reagent merge with each other, producing a mixed solution, first, the sample that has been sent until the sample pump 15 enters the normal operation state, and the first reagent that has been sent until the first reagent pump 14 enters the normal operation state, merge with each other, Accordingly, as illustrated in FIG. 4B, the uncertain mixed solution α with an uncertain mixing ratio passes through the microchannel 1.

Next, the sample that has been sent after the sample pump 15 has entered the normal operation state, and the first reagent that has been sent after the first reagent pump 14 has entered the normal operation state, merge with each other. Accordingly, as illustrated in FIG. 4C, the mixed solution β with a desired mixing ratio passes through the inside of the microchannel 1, following the uncertain mixed solution α. That is, if the mixed solution β of the sample and the first reagent passes up to the first photometry cell 11 in a state in which the uncertain mixed solution α is present in front of the mixed solution β in the travelling direction, the uncertain mixed solution α is likely to be subjected to a test as a test subject.

However, as described above, the uncertain mixed solution that has been sent until both of the sample pump 15 and the first reagent pump 14 enter the normal operation state cannot be used in a test because the mixing ratio is not stable. Accordingly, it is needed to separate the uncertain mixed solution from the microchannel 1.

For such a reason, the mixing cartridge 200 of this embodiment separates the uncertain mixed solution from the microchannel 1 by introducing it into the first discard microchannel 6. That is, if the uncertain mixed solution reaches the branching point 51 of the microchannel 1 and the first discard microchannel 6 in the mixing cartridge 200, the uncertain mixed solution is sucked up into the first discard microchannel 6 due to capillary action.

Hereinafter, a description will be made on a case where the uncertain mixed solution resulting from the merge of the sample and the first reagent is separated, with reference to the drawings. FIGS. 5A, 5B, and 5C are explanatory diagrams illustrating the process in which the uncertain mixed solution is sucked into to the first discard microchannel 6. FIG. 5A is an explanatory diagram illustrating a state in which the sample and the first reagent are mixed and then the uncertain mixed solution α has passed through the inside of the microchannel 1 and reached the branching point 51. FIG. 5B is an explanatory diagram illustrating a state in which the uncertain mixed solution α has been sucked up into the first discard microchannel 6. FIG. 5C is an explanatory diagram illustrating a state in which the mixed solution β with a stable mixing ratio is passing through the inside of the microchannel 1 after the uncertain mixed solution α is sucked up into the first discard microchannel 6. FIG. 5A, as in FIG. 4B, illustrates the state in which the uncertain mixed solution α with an uncertain mixing ratio has passed through the microchannel 1 and reached the branching point 51. After that, in the mixing cartridge 200 of this embodiment, as illustrated in FIG. 5B, the uncertain mixed solution α branches off (is eliminated) from the microchannel 1 in a manner such that the uncertain mixed solution α is sucked up into the first discard microchannel 6, the mixed solution β with a desired mixing ration passes after the uncertain mixed solution α.

Accordingly, as illustrated in FIG. 5C, if the uncertain mixed solution α is held in the first discard microchannel 6, only the mixed solution β, which has followed the uncertain mixed solution α, keeps passing through the microchannel 1. That is, the mixed solution β of the sample and the first reagent passes up to the first photometry cell 11 in a state in which the uncertain mixed solution α is not present in front of the mixed solution β in the travelling direction. Accordingly, the uncertain mixed solution α is not subjected to a test as a test subject.

In this case, it is necessary to design in advance the first discard microchannel 6 to have a capacity sufficient to suck up the uncertain mixed solution. As exemplified in FIGS. 3A and 33, the capacity of the first discard microchannel 6 can be designed on the basis the operational performance of the pumps and the mixing ratio of the reaction reagent. The design value of the discard microchannel is not particularly limited. That is, as long as the size thereof enables the uncertain mixed solution to be sucked up due to capillary action, the structure and size thereof are not particularly limited. Furthermore, in order to more actively use the capillary action, a process for imparting a hydrophilic property to the inside of the discard microchannel may be performed. In this way, the uncertain mixed solution with an uncertain mixing ratio is introduced into the first discard microchannel 6 in the mixing cartridge 200. Accordingly, it is possible to cause the uncertain mixed solution with an uncertain mixing ratio to branch off, or it is possible to separate the uncertain mixed solution with an uncertain mixing ratio from the microchannel 1.

Returning to FIG. 2, the mixed solution of the sample and the first reagent which results from the removal of the uncertain mixed solution is delivered up to the first magnet 19 provided in the microchannel 1. The first magnet 19 agitates the sample and the first reagent to promote a reaction by its infinitesimal motion caused by the first agitation control unit 18. The sample pump 15 and the first reagent pump 14 stop sending of solution after they are driven to operate for a predetermined time. After that, the oil (not particularly limited thereto as long as it is a solution that is immiscible with water) inside the oil tank 7 is sent to the microchannel 1 by the oil pump 17 to deliver the mixed solution. The oil is continuously delivered by driving the oil pump 17 until the first photometry cell 11 disposed inside the microchannel 1 is filled with the mixed solution.

When the test using an optical technique finishes, the oil pump 17 is driven again to deliver the mixed solution. When the mixed solution reaches the second reagent tank 24, the second reagent pump 34 starts sending the second reagent.

As in the case of mixing the sample with the first reagent, a mixed solution (uncertain mixed solution), in which a mixing ratio of the mixed solution obtained by mixing the sample with the first reagent with respect to the second reagent is uncertain, is separated from the microchannel 1 by being introduced into the second discard microchannel 16. After that, the mixed solution is agitated by the second magnet 29 and the second agitation control unit 28, so that mixing is promoted. After that, when the second photometry cell 21 disposed in the microchannel 1 is filled with the mixed solution, the test using an optical technique is performed again with the optical testing unit 300 (see FIG. 1).

For some measurement items, the test may be performed with only the first reagent. In such cases, the structure involved in the mixing of the second reagent may not be equipped. As the pump for performing delivery of a liquid, the syringe pump is used. However, it is not particularly limited thereto but may be a plunger type, a piezoelectric type, or any of other types as long as it can perform the delivery of a liquid.

Furthermore, the parts making contact with the sample such as the sample tank 5, the first discard microchannel 6, the second discard microchannel 16, the first magnet 19, the second magnet 29, the mixing cartridge 200 forming the microchannel 1 therein, or the like may be replaced for each sample in order to reduce the testing error that may be attributable to mixing with other samples. The reagent tanks 4 and 24, and the oil tank 7 may also be configured to be replaced for each sample.

In the embodiment, agitation for mixing the mixed solution is performed by employing the first magnet 19, the second magnet 29, the first agitation control unit 18, and the second agitation control unit 28, but other structures may be used. Although the mixed solution is delivered by the oil pump 17, other methods may be employed to obtain the same effects as those of the embodiment.

Referring to FIG. 2, the first magnet 19 that agitates a solution is installed on the downstream from the branching point 51 of the first discard microchannel 6. However, it does not matter on which side the first magnet 19 is disposed, on the downstream or on the upstream from the branching point 51 of the first discard microchannel 6. However, if the solution with an uncertain mixing ratio reaches the first magnet 19, there occurs a slight error in the mixing ratio of the mixed solution used in the test, which results in a degradation in test accuracy. Accordingly, it is preferable that the branching point 51 branching off from the first discard microchannel 6 is provided on the upstream from the first magnet 19. This structure may be similarly applied to the case of performing mixing with the second reagent.

FIG. 6 is a block diagram illustrating the functional structure of the control unit 400. Parts corresponding to FIG. 2 will be denoted by the same signs and the description thereof is not made repetitively. As illustrated in FIG. 6, the control unit 400 includes a measurement item selecting unit 100, a measurement item database (hereinafter, referred to as “DB”) 2 serving as a storage unit, and an operation control unit 3.

The measurement item selecting unit 100 functions as a selecting unit. For example, it receives an item to be tested of a sample as an input through a keyboard or the like and outputs a signal corresponding thereto to the operation control unit 3. The measurement item DB 2 is a recording medium such as a memory which stores rated flow rates specified to mix the sample, the first reagent, and the second reagent at mixing ratios associated with measurement items, driving times of the first reagent pump 14, the sample pump 15, and the second reagent pump 34 that perform liquid sending, and the like. The operation control unit 3 fetches various kinds of parameters stored in the measurement item DB 2 and controls operation times and operation timings of the liquid sending pumps and the agitation control unit on the basis of the parameters.

Hereinafter, referring to FIG. 6, the details of the driving operation of the liquid sending pumps are described. When the measurement item is input to the measurement item selecting unit 100, the relevant signal is output to the operation control unit 3. The operation control unit 3 sends an operation signal so that the first reagent pump 14 and the sample pump 15 operate to deliver liquids to the microchannel 1 under conditions of the time and rated flow rate corresponding to the measurement item which is input. The first reagent pump 14 and the sample pump 15 are controlled to start the liquid sending operation such that the sample and the first reagent may simultaneously merge with each other at the confluent point 41 and to give the rated flow rates, The first reagent and the sample are mixed at the confluent point 41 of the inside of the microchannel 1, thereby producing a mixed solution.

As described with reference to FIGS. 3A and 3B, since a mixing ratio of part of a mixed solution, which has been sent until both the first reagent pump 14 and the sample pump 15 enter a constant driving operation state, is uncertain, the part needs to be separated from the microchannel 1. An amount of the uncertain mixed solution obtained before the mixing ratio is stabilized is determined depending on the measurement item. Accordingly, the first discard microchannel 6 needs to be designed according to the measurement item. In a manner of introducing the uncertain mixed solution of a discarding amount corresponding to the measurement item into the first discard microchannel 6, it is possible to efficiently separate the uncertain mixed solution from the microchannel 1. The uncertain mixed solution is introduced into the first discard microchannel 6 to be separated from the microchannel 1, and the first reagent pump 14 and the sample pump 15 enter the normal operation state and the mixing ratio becomes constant, so that measurement is enabled. The operation control unit 3 drives the first agitation control unit 18 to operate at timing when the solution, of which the mixing ratio becomes constant, reaches the first magnet 19 that agitates a solution, so that agitation of the sample and the first reagent is promoted by vibration of the first magnet 19.

Then, if the sample and the first reagent are sent in sufficient amounts required to perform a test, the operation control unit 3 performs control of causing the first reagent pump 14 and the sample pump 15 to stop the liquid sending operation. If the first reagent pump 14 and the sample pump 15 stop their liquid sending operations, the operation control unit 3 sends a driving operation signal to the oil pump 17 for use in delivery. The mixed solution of the first reagent and the sample is delivered up to the first photometry cell 11 by oil.

The first agitation control unit 1B performs control of causing the first magnet 19 to keep vibrating until the leading end part of the delivery oil reaches a position where the first magnet 19 is present and of stopping vibration of the first magnet 19 when the leading end part of the delivery oil reaches the position where the first magnet is present. In this way, it is possible to prevent the oil and the mixed solution from undesirably mixed with each other by the agitation operation according to the measurement item,

If the liquid sending of the mixed solution ends and the first photometry cell 11 is filled with the mixed solution, the oil pump 17 stops the delivery due to oil, and the optical test is performed with the optical testing unit 300. When the test finishes, the oil pump 17 resumes liquid-sending to send the oil to the microchannel 1.

The mixed solution of the first reagent and the sample is delivered. The operation control unit 3 sends an operation signal so that the second reagent pump 34 performs an operation of sending a liquid to the microchannel 1 under the conditions of the rated flow rate and the time selected according to the input measurement item. The second reagent pump 34 starts its liquid-sending operation so that the mixed solution of the first reagent and the sample, and the second reagent may simultaneously merge with each other at the confluent point 42, and performs control of giving the rated flow rate. The mixed solution of the first reagent and the sample, and the second reagent are mixed at the confluent point 42 inside the microchannel 1 so as to produce a mixed solution.

The oil pump 17 has entered a normal operation state of giving the rated flow rate when the second reagent pump 34 starts its liquid-sending operation. In addition, a time difference is caused from timing when the second regent pump 34 receives an operation start signal to timing when it enters a normal operation state of giving the rated flow rate. Accordingly, the mixing ratio of the mixed solution of the first reagent, the sample, and the second reagent that has been sent until the second reagent pump 34 enters the normal operation state is uncertain. In a manner of introducing the uncertain mixed solution of a discarding amount selected according to the measurement item into the second discard microchannel 16, it is possible to efficiently separate the uncertain mixed solution from the microchannel 1.

If the second reagent pump 34 reaches the rated operation, the oil pump 17 and the second reagent pump 34 keep performing their liquid sending operations. If the sample and the second reagent are sent in sufficient amounts required to perform a subsequent test, the second reagent pump 34 stops its liquid sending operation, but the oil pump 17 is continuously driven to operate. If the second photometry cell 21 is filled with the mixed solution agitated by the second agitation control unit 28, the oil pump 17 stops operating, and an optical test is performed with the optical testing unit 300. When the photometry finishes, the test using the sample testing device according to the embodiment ends.

All operation timings for all measurement items are stored in the measurement item DB 2 in the device. A mechanism of driving and operating various types of pumps according to the operation timings has been described.

In the mixing cartridge 200 of the sample testing device 500 according to the first embodiment, it is possible to efficiently separate the uncertain mixed solution of an amount that is determined according to the measurement item from the mixed solution passing through the microchannel 1 by employing the first discard microchannel 6 and the second discard microchannel 16, and to perform a test on a sample with high accuracy with use of a trace of sample and reaction reagent.

### Second Embodiment

The mixing cartridge according to the first embodiment is configured such that the discard microchannel communicating with the microchannel separates the uncertain mixed solution passing through the microchannel. In a mixing cartridge according to a second embodiment described below, an uncertain mixed solution passing through a microchannel can be separated by a discard microchannel communicating with the microchannel and charged with a wick material that absorbs a liquid.

First, the structure of a sample testing device is the same as that of the first embodiment, and thus a description thereof will not be repeated (see FIG. 1). FIG. 7 is a schematic diagram illustrating the structure of a mixing cartridge 201 according to the second embodiment. In the mixing cartridge 201 illustrated in FIG. 7, a first discard microchannel 26 and a second discard microchannel 36 are installed instead of the first discard microchannel 6 and the second discard microchannel 16 of the mixing cartridge 200 of the first embodiment, but the other structure is the same as that of the first embodiment, so that a description thereof will not be repeated.

The first discard microchannel 26 branches off from a microchannel 1 in a way of communicating with the microchannel 1 at a downstream position of the microchannel 1 from a confluent point 41 of a first reagent, a sample, and an oil. FIG. 8 is an explanatory diagram illustrating the details of the first discard microchannel 26. As illustrated in FIG. 8, the first discard microchannel 26 is formed to have a diameter smaller than the diameter of the microchannel 1. Furthermore, the inside of the first discard microchannel 26 is charged with a wick material having wick performance, such as unwoven cloth, and an end of the wick material 261 is disposed to be in contact with the microchannel 1.

With this structure, when a mixed solution which is a mixture of a sample and a first reagent passes a branching point 51 of the microchannel 1 and the first discard microchannel 26 charged with the wick material 261, an uncertain mixed solution (part of a mixed solution), out of a mixed solution that passes through the microchannel 1, is absorbed by the wick material 261 by capillary action. In this way, as in the first embodiment, the uncertain mixed solution is separated from the mixed solution. Further, in this case, it is necessary to design the first discard microchannel 26 and the wick material 261 in advance in such a manner that the uncertain mixed solution is sufficiently sucked up. As illustrated in FIGS. 3A and 3B, the first discard microchannel 26 and the wick material 261 can be designed on the basis of the operation performance of the pumps and the mixing ratio of the reaction reagent. The wick material 261 may not be necessarily limited to particular ones as long as it has wick performance.

The second discard microchannel 36 also has the same structure as described above and is charged with a wick material 361. In addition, the operation of the sample testing device 500 including the mixing cartridge 201 of this embodiment is the same as that of the first embodiment. The first discard microchannel 26 and the second discard microchannel 36 according to this embodiment are formed to have a diameter smaller than the diameter of the microchannel 1 as described above. However, the scales of the first discard microchannel 26, the second discard microchannel 36, and the microchannel 1 in FIG. 7 may not correspond to actual dimensions.

In the mixing cartridge 201 of the sample testing device 500 according to the second embodiment, by provision of the first discard microchannel 26 charged with the wick material 261 and the second discard microchannel 36 charged with the wick material 361, it is possible to efficiently separate the uncertain mixed solution of an amount corresponding to the measurement item from the mixed solution passing through the microchannel 1, and to perform a highly accurate sample test with a trace of a sample and a reaction reagent.

### Third Embodiment

In the mixing cartridge of the second embodiment, the discard microchannel charged with the wick material is configured to be disposed on the downstream position from the confluent point of the sample and the reaction reagent in the microchannel. In a mixing cartridge of the third embodiment that will be described below, a discard microchannel charged with a wick material is disposed on the upstream from a confluent point of a sample and a reaction reagent.

The structure of a sample testing device is the same as that of the first embodiment and thus a description thereof will not be repeated (see FIG. 1). FIG. 9 is a schematic diagram illustrating the structure of a mixing cartridge 202 according to the third embodiment. In the mixing cartridge 202 illustrated in FIG. 9, a first discard microchannel 46, a second discard microchannel 56, and a third discard microchannel 66 are installed instead of the first discard microchannel 6 and the second discard microchannel 16 of the mixing cartridge 200 of the first embodiment. The other structure is the same as that of the first embodiment and thus a description thereof will not be repeated.

The first discard microchannel 46 branches off from a miorochannel 1b in a manner of communicating with the microchannel 1b, through which a first reagent sent from a first reagent tank 4 passes, in the vicinity of a first reagent tank 4, at an upstream position from a confluent point 41 of a microchannel 1 where a first reagent, a sample, and an oil merge into one another. The first discard microchannel 46 is formed to have a diameter smaller than the diameter of the microchannel 1b. The first discard microchannel 46 is installed in such a manner that the inside of the first discard microchannel 46 is charged with a wick material 461 having wick performance such as unwoven cloth, and an end of the wick material 461 is in contact with the microchannel 1b.

With this configuration, when a first reagent passes a bifurcation point between the microchannel 1b and the first discard microchannel 46 charged with the wick material 461, an uncertain first reagent (part of the first reagent) out of the first reagent passing through the microchannel 1b is absorbed by the wick material 461 by capillary action. Thus, the uncertain first reagent is separated from the first reagent. Here, the “uncertain first reagent” is part of the first reagent with which the sample and the first reagent are mixed at a ratio different from a mixing ratio determined according to the measurement item to be tested, and also means the first reagent that has been sent from a first reagent tank 4 until a first reagent pump 14 enters a normal operation state.

A second discard microchannel 56 branches off from a microchannel 1a in a manner of communicating with the microchannel 1a, through which a sample sent from a sample tank 5 passes, in the vicinity of the sample tank 5, on an upstream position from a confluent point 41 of the microchannel 1 where the first reagent, the sample, and an oil merge into one another. The second discard microchannel 56 is formed to have a diameter smaller than the diameter of the microchannel 1a like the first discard microchannel 46, and is installed in such a manner that the inside of the second discard microchannel 56 is charged with a wick material 561 and an end of the wick material 561 is in contact with the microchannel 1a.

With this configuration, when the second reagent passes a branching point between the microchannel 1a and the second discard microchannel 56 charged with the wick material 561, an uncertain sample (part of the sample) out of the sample passing through the microchannel 1a is absorbed by the wick material 561 by capillary action. Thus, the uncertain sample is separated from the sample. Here, the “uncertain sample” is part of the sample with which the sample and the first reagent are mixed at a ratio different from a mixing ratio determined according to the measurement item to be tested, and also means the sample that has been sent from a sample tank 5 until a sample pump 15 enters a normal operation state.

The third discard microchannel 66 branches off from a microchannel 1e in a manner of communicating with the microchannel 1e, through which a second reagent sent from a second reagent tank 24 passes, in the vicinity of the second reagent tank 24, on an upstream position from a confluent point 42 of the microchannel 1 where a mixed solution of the first reagent and the sample, and a third reagent merge into one another. The third discard microchannel 66 is formed to have a diameter smaller than the diameter of the microchannel 1e like the first discard microchannel 46, and is installed in such a manner that the inside of the third discard microchannel 66 is charged with a wick material 661 and an end of the wick material 661 is in contact with the microchannel 1e.

With this configuration, when the second reagent passes a branching point between the microchannel 1e and the third discard microchannel 66 charged with the wick material 661, an uncertain second reagent (part of a second reagent) out of the second reagent passing through the microchannel 1e is absorbed by the wick material 661 by capillary action. Thus, the uncertain second reagent is separated from the second reagent. Here, the “uncertain second reagent” means part of the second reagent with which the mixed solution of the sample and the first reagent, and the second reagent are mixed at a ratio different from a mixing ratio determined according to the measurement item to be tested, and also means the second reagent that has been sent from the second reagent tank 24 until a second reagent pump 34 enters a normal operation state.

Next, the operation of the sample testing device 500 including the mixing cartridge 202 according to this embodiment will be described. As described in the first embodiment, the sample stored in the sample tank 5 is sent to the microchannel 1 by the sample pump 15. The first reagent stored in the first reagent tank 4 is sent to the microchannel 1 by the first reagent pump 14. The second reagent stored in the second reagent tank 24 is sent to the microchannel 1 by the second reagent pump 34. The first reagent and the sample are sent in such a manner that they are simultaneously supplied to the confluent point 41 inside the microchannel 1. The first reagent and the sample merge with each other to be mixed at the confluent point 41, and a mixed solution thereof is obtained.

However, when the uncertain sample that has been sent until the sample pump 15 enters the normal operation state, and the uncertain first reagent that has been sent until the first reagent pump 14 enters the normal operation state, are mixed with each other, a mixed solution with an unstable mixing ratio is obtained. Accordingly, the mixed solution thus obtained cannot be used for measurement. Accordingly, it is necessary to separate the uncertain sample and the uncertain first reagent from the microchannel 1.

The mixing cartridge 202 of this embodiment separates the uncertain first reagent from the microchannel 1b by introducing the uncertain first reagent into the inside of the first discard microchannel 46, and separates the uncertain sample from the microchannel 1a by introducing the uncertain sample into the second discard microchannel 56. That is, in the mixing cartridge 202, if the uncertain first reagent reaches the branching point between the microchannel 1b and the first discard microchannel 46, the uncertain first reagent is sucked up into the first discard microchannel 46 by capillary action. When the uncertain sample reaches a branching point between the microchannel 1a and the second discard microchannel 56, the uncertain sample is sucked up into the second discard microchannel 56 by capillary action.

In this case, the first discard microchannel 46 and the second discard microchannel 56 need to be designed in advance so as to have capacities sufficient to suck up the uncertain first reagent and the uncertain sample, respectively. According to the first embodiment, as illustrated in FIGS. 3A and 3B, the capacities of the first discard microchannel 46 and the second discard microchannel 56 can be designed on the basis of the operation performances of the pumps and the mixing ratio of the reaction reagent. As such, in the mixing cartridge 202, the uncertain first reagent and the uncertain sample can be branched off from or separated from the microchannel 1 before they reach the confluent point 41. Accordingly, the first reagent and the sample are mixed with a desirable mixing ratio at the confluent point 41, and thus a stabilized mixed solution can be obtained.

The mixed solution of the sample and the first reagent from which the uncertain first reagent and the uncertain sample are eliminated is delivered to the first magnet 19 inside the microchannel 1. Here, the agitation operation between the sample and the first reagent and the testing by the first photometry cell 11 are performed in the same manner as in the first embodiment.

Like in the case of mixing the sample with the first reagent, a second reagent (an uncertain second reagent), of which a mixing ratio with a mixed solution obtained by mixing the sample and the first reagent is uncertain, is separated into the third discard microchannel 66 from the microchannel 1e. After that, the second reagent is mixed with the mixed solution (the mixed solution obtained by mixing the sample with the first reagent), and agitated by the second magnet 29 and the agitation control unit 28, so that the mixing is promoted. After that, if the second photometry cell 21 disposed inside the microchannel 1 is filled with the mixed solution obtained by mixing the sample, the first reagent, and the second reagent, a test using an optical technique is performed with the optical testing unit 300 (see FIG. 1).

In the mixing cartridge 202 of the sample testing device 500 according to the third embodiment, by the provision of the first discard microchannel 46 charged with the wick material 461, the second discard microchannel 56 charged with the wick material 561, and the third discard microchannel 66 charged with the wick material 661, it is possible to efficiently separate the first reagent, sample, and second reagent that are uncertain and pass through the microchannel 1, of an amount which depends on the measurement item, and to surely test the sample with high accuracy using a smaller amount of sample and reaction reagent.

In the first embodiment described above, the discard microchannel is provided in the microchannel. In the second and the third embodiments, the discard microchannel charged with the wick material is provided in the microchannel. However, the structure is not limited thereto. Any structure may be employed as long as a discard unit, which separates an uncertain mixed solution or an uncertain solution existing before mixing, is provided in the microchannel.

According to the first and the second embodiments, the first discard microchannels 6 and 26 communicate with the microchannel 1 in the vicinity of the midway position between the confluent point 41 and the installation position of the first magnet 19, but are not limited thereto. That is, they may communicate with the microchannel 1 at any position as long as the position is on the downstream from the confluent point 41 but on the upstream from the installation position of the first magnet 19. Similarly, the second discard microchannels 16 and 36 communicate with the microchannel 1 in the vicinity of the midway position between the confluent point 42 and the installation position of the second magnet 29, but are not limited thereto. That is, they may communicate with the microchannel 1 at any position as long as the position is on the downstream from the confluent point 42 but on the upstream from the installation position of the second magnet 29.

According to the third embodiment, the first discard microchannel 46 is installed on the microchannel 1b, in the vicinity of the first reagent tank 4, but is not limited thereto. That is, it may communicate with the microchannel 1b at any position on the upstream from the confluent point 41. Similarly, the second discard microchannel 56 is installed on the microchannel 1a, in the vicinity of the sample tank 5 but is not limited thereto. That is, it may communicate with the microchannel 1a at any position on the upstream from the confluent point 41. In the same manner, the third discard microchannel 66 is installed on the microchannel 1e, in the vicinity of the second reagent tank 24 but is not limited thereto. That is, it may communicate with the microchannel 1e at any position on the upstream position from the confluent point 42.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A mixing cartridge that mixes a first solution containing a sample with a second solution corresponding to a measurement item of the sample to be tested, comprising:
a member in which a channel is formed, a solution containing at least one of the first solution and the second solution passing through the channel;
a first liquid supplying unit configured to supply the first solution to the channel;
a second liquid supplying unit configured to supply the second solution to the channel; and
a separating unit configured to communicate with the channel and separates a portion of the solution from the solution passing through the channel by capillary action.

2. The mixing cartridge according to claim 1,
wherein the separating unit communicates with the channel at a position which is on the downstream from a confluent position where the first solution and the second solution merge with each other to produce a mixed solution, and separates a portion of the mixed solution by capillary action.

3. The mixing cartridge according to claim 2,
wherein the separating unit separates by capillary action, from the mixed solution passing through the channel, an uncertain solution which is a portion of the mixed solution and in which the first solution and the second solution are mixed at a ratio different from a mixing ratio determined according to the measurement item.

4. The mixing cartridge according to claim 1,
wherein the separating unit communicates with the channel at a position which is on the upstream from a confluent position where the first solution and the second solution merge with each other, and separates a portion of the solution passing through the channel by capillary action.

5. The mixing cartridge according to claim 1,
wherein the separating unit includes a discard channel which has a diameter smaller than that of the channel and branches off from the channel.

6. The mixing cartridge according to claim 5,
wherein the separating unit includes a wick material that charges the inside of the discard channel and absorbs a liquid.

7. The mixing cartridge according to claim 1,
wherein the first liquid supplying unit includes:
a first tank configured to contain the first solution; and
a first pressure control unit configured to control a pressure inside the first tank, wherein the first liquid supplying unit supplies the first solution to the channel by changing of the pressure, and
the second liquid supplying unit includes:
a second tank configured to contain the second solution; and
a second pressure control unit configured to control a pressure inside the second tank, wherein the second liquid supplying unit supplies the second solution to the channel by changing of the pressure.

8. The mixing cartridge according to claim 7,
wherein the first pressure control unit and the second pressure control unit are syringe pumps.

9. The mixing cartridge according to claim 1, further comprising an agitating member configured to agitate a mixed solution which is a mixture of the first solution and the second solution before the sample is tested.

10. A sample testing device that tests a sample using a mixed solution which is a mixture of a first solution containing a sample and a second solution corresponding to a measurement item of the sample to be tested, comprising:
a member in which a channel is formed, a solution containing at least one of the first solution and the second solution passing through the channel;
a first liquid supplying unit configured to supply the first liquid to the channel;
a selecting unit configured to select the measurement item;
a second liquid supplying unit configured to supply the second solution to the channel;
a separating unit configured to communicate with the channel and to separate a portion of the solution by capillary action from the solution passing through the channel; and
a testing unit configured to test the sample by emitting light to the mixed solution from which the portion of the solution in the channel is separated.

11. A sample testing device that tests a sample using a first mixed solution which is a mixture of a first solution containing the sample and a second solution corresponding to a first measurement item of the sample to be tested, comprising:
a member in which a channel is formed, a solution containing at least one of the first solution and the second solution passing through the channel;
a first liquid supplying unit configured to supply the first solution to the channel;
a selecting unit configured to select the first measurement item;
a second liquid supplying unit configured to supply the second solution to the channel;
a separating unit configured to communicate with the channel at a position which is on the downstream from a first confluent position where the first solution and the second solution merge with each other, and to separate by capillary action, from the first mixed solution mixed at the first confluent position, a first uncertain mixed solution which is a portion of the first mixed solution in which the first solution and the second solution are mixed at a ratio that is different from a mixing ratio determined according to the first measurement item; and
a testing unit configured to test the sample by emitting light to the first mixed solution from which the first uncertain mixed solution in the channel is separated.

12. The sample testing device according to claim 11,
wherein the sample testing device tests the'sample using a second mixed solution which is a mixture of the first mixed solution and a third solution corresponding to a second measurement item of the sample to be tested,
the channel is formed in the member, the solution containing at least one of the third solution and the first mixed solution passing through the channel;
the sampling testing device further includes a third liquid supplying unit configured to supply the third solution to the channel,
the selecting unit further selects the second measurement item,
the separating unit communicates with the channel additionally at a position which is on the downstream from a second confluent position where the first mixed solution and the third solution merge with each other and separates by capillary action, from a second mixed solution mixed at the second confluent position, a second uncertain mixed solution which is a portion of the second mixed solution in which the first mixed solution and the third solution are mixed at a ratio different from a mixing ratio determined according to the second measurement item, and
the testing unit tests the sample by emitting light to the second mixed solution from which the second uncertain mixed solution in the channel is separated.
